(19) United States
(12) Patent Application Publication
(10) Pub. No.: US 2012/0027119 A1
(43) Pub. Date: Feb. 2, 2012

(54) Mixed mode modulation for OFDM

(76) Inventor: Edwin H.S. Shearer, Pleasanton, CA (US)

(21) Appl. No.: 13/012,075

(22) Filed: Jan. 24, 2011

Related U.S. Application Data
(63) Continuation-in-part of application No. 12/816,302, filed on Jun. 15, 2010, now abandoned.
Application No. 12/816,302 is a continuation-in-part of application No. 12/942,616, filed on Nov. 9, 2010, now abandoned.

(51) Int. Cl. H04L 27/06; H04L 27/04

(52) U.S. Cl. 375/295; 375/340

(57) ABSTRACT

In a wireless OFDM communication system such as a neighborhood area network, one or more of the following features may be used to increase throughput while accommodating worst-case channel conditions. Firstly, the cyclic prefix may be chosen to be greater than or equal to the longest delay profile that could reasonably be expected so that either demodulation method can be accommodated. Secondly, the number of pilots may be chosen to be less than that required by the worst case channel so that the data rate is maximized for a large portion of the channels in use. Thirdly, the data packet may be constructed such that the demodulation mode employed for data payload encoding is signaled in the first portion of the data packet often referred to as the PHY Header. The PHY Header is always transmitted as a coherent modulation including data and pilot tones.

### RELATED APPLICATIONS

This application claims benefit of U.S. Provisional Application 61/259,261 of the present inventor filed Nov. 9, 2009 entitled Affordable OFDM for Smart Utility Networks (SUN), and is a continuation-in-part of U.S. application Ser. No. 12/816,302 of the present inventor filed Jun. 15, 2010 entitled Affordable OFDM for Smart Utility Networks (SUN), and a continuation-in-part of U.S. application Ser. No. 12/942,616 of the present inventor filed Nov. 9, 2010 entitled Mixed Mode Modulation for OFDM, all of which are incorporated herein by reference.

### BACKGROUND

OFDM is an efficient modulation scheme used in a wide variety of wireless data transmission schemes and uses a number of orthogonal data carriers to carry the data. The data to be transmitted is encoded as a phase modulation on each of the individual carriers in the frequency domain. An inverse Fourier transform is used to convert the information to the time domain whereupon the time domain waveform is applied to the transmitter. The result of each inverse transform is commonly called a symbol. Reception of the signal uses the reverse process where the received waveform is converted to the frequency domain by a Fourier transform, and the data is recovered by examination of the phases of each of the carriers.

Wireless channels exhibit two main characteristics that adversely affect decoding of the received OFDM waveform, multipath and time dependent fading. Multipath, caused by reflections of the radio wave from objects in the environment, results in delayed versions of each symbol that interfere with subsequent symbols as they arrive at the receiver. A common method to mitigate this problem is space the symbols in time by an amount more than the maximum expected multipath. Some implementations transmit zero power in this space, effectively leaving a gap between symbols. Other implementations fill the gap with a cyclic repetition of a portion of the symbol—usually referred to as a cyclic prefix.

While this approach mitigates the problem in the time domain, the channel impulse response imposes a frequency response such that certain frequencies are attenuated, or amplified more than others. The channel also imposes a phase response which changes with frequency.

Furthermore, since the channel impulse response also changes with time, demodulation of the data by examining the phase of each carrier impossible, unless the time dependent channel induced phase is know, or can be estimated.

Some OFDM systems encode the phases on each carrier differentially between symbols meaning that the data can be decoded by examining only the difference in phases between carriers in each symbol thus making knowledge of the absolute phase of the channel unnecessary.

Other OFDM systems intersperse carriers of known phase between the data carriers. These pilot carriers can then be used to infer the absolute channel phase response for nearby carriers by interpolation or other means.

The question of how many pilots are needed to accurately determine the complete phase response is a topic studied by many. This relationship is described very succinctly in Rohit Negi and John Cioffi, PILOTTONE SELECTION FOR CHANNEL ESTIMATION IN A MOBILE OFDM SYSTEM, Information Systems Laboratory, Stanford University, Stanford, Calif. 94305. Their study shows that the number of pilots necessary is linearly related to the length of the channel delay profile, and since the length of the cyclic prefix is usually designed in accordance with the length of the delay profile, they relate the number of pilots directly to the length of the cyclic prefix.

Thus if the channel delay profile is expected to be ¼ of a symbol, the cyclic prefix would be set to ¼ of a symbol, and ¼ of the data carriers should be used as pilots. This results in a substantial overhead and limits the data rate because would-be data carriers must be used as pilots.

The IEEE 802.15.4 g standard is designed for radio communication in a neighborhood area network (NAN) where the majority of radio links are house-to-house and relatively short. In these types of networks the bulk of the radio links have relatively short delay profiles implying that the number of data carriers could be reduced and this is a good engineering compromise. However there will always remain some links that do have the maximum delay profile and these would therefore be impossible to demodulate using a pilot based demodulation scheme, but could be demodulated using a differential encoding scheme.

While differential encoding does not require pilots for demodulation it is not able to use the higher order modulation schemes such as 16QAM so it also has limitations on the data rate that such a system could work at so the choice between a differentially encoded system or a pilot based system is not an easy decision. Unfortunately the two modes require different demodulators, and since the receiver does not know apriori which mode is being used it is not possible to demodulate the data.

### SUMMARY

This invention seeks to solve the problems outlined above. In some embodiments, the solution may include some or all of the following features:
Firstly, the cyclic prefix may be chosen to be greater than or equal to the longest delay profile that could reasonably be expected so that either demodulation method can be accommodated.
Secondly, the number of pilots may be chosen to be less than that required by the worst case channel so that the data rate is maximized for a large portion of the channels in use.
Thirdly, the data packet may be constructed such that the demodulation mode employed for data payload encoding is signaled in the first portion of the data packet often referred to as the PHY Header. The PHY Header is always transmitted as a coherent modulation including data and pilot tones.

### DRAWING FIGURES

The present invention may be further understood from the following description in conjunction with the appended drawing figures. In the drawing figures:

FIG. 1 is a diagram of a wireless neighborhood area network.

FIG. 2 is a diagram of a portion of a node of the network of FIG. 1.

FIG. 3 is a diagram of a packet structure that may be used in the network of FIG. 1.

FIG. 4 is a flowchart of a communications method.

FIG. 4A is a flowchart of another communications method.

FIG. 5 is flowchart of another communications method.

FIG. 6 is a flowchart of another communication method.

### DETAILED DESCRIPTION

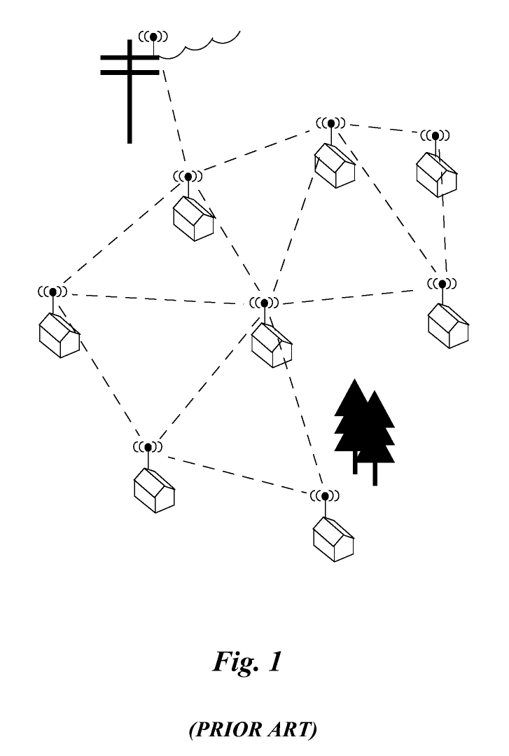

Referring now to FIG. 1, a conceptual diagram is shown of a wireless neighborhood area network in which mixed mode OFDM modulation may be used. The neighborhood area network may be residential, commercial, industrial, or some combination of the same. In the illustrated embodiment, the network is a mesh network. Connectivity may be less than complete. At least one node connects to wired infrastructure, illustrated in this example as a pole-top node coupled also to a wired network. Each node is provided with connectivity to the pole-top node through one or more network hops.

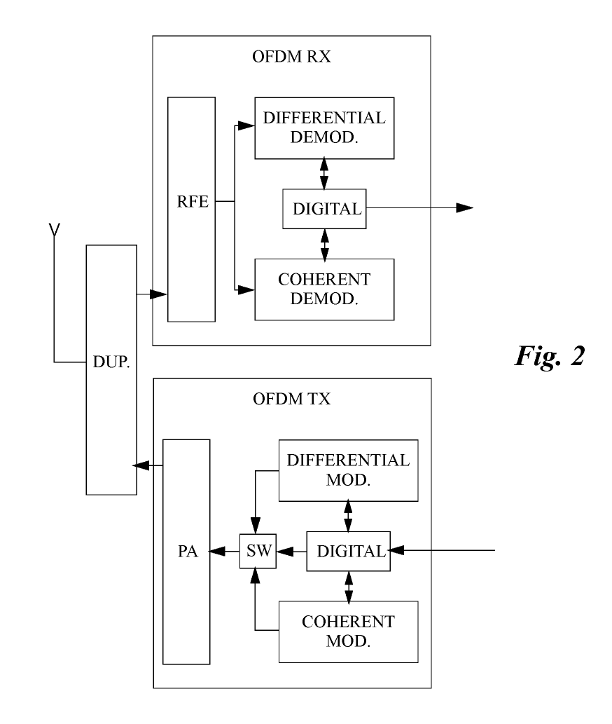

A diagram of a portion of a node of the network of FIG. 1 in accordance with an exemplary embodiment is shown in FIG. 2. The blocks of FIG. 2 may be realized in hardware, software, or a combination of hardware and software. An antenna is coupled to a duplexer, which is coupled in turn to an OFDM transceiver having a transmitter portion and a receiver portion.

The receiver portion includes a radio front end coupled to the duplexer. The radio front end produces a radio frequency output signal that is coupled to both a coherent demodulator and a differential demodulator. A digital portion of the receiver is coupled to the coherent demodulator and the differential demodulator. The digital portion determines which of the demodulators is used at a given time. It receives the demodulated information and passes that information on to other circuitry (not shown).

The transmitter portion includes a power amplifier coupled to the duplexer. The power amplifier produces a radio frequency output signal in response to one of a coherent modulator and a differential modulator. A switch selects either an output of the coherent modulator or an output of the differential modulator under control of a digital portion of the transmitter. The digital portion is coupled to the coherent modulator and the differential modulator. It determines which of the modulators is used at a given time. It receives information from other circuitry (not shown) and passes that information on to a selected one of the coherent modulator and the differential modulator.

### Typical Data Packet Construction

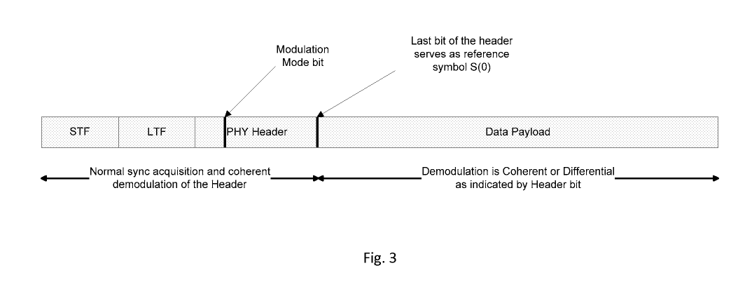

FIG. 3 shows the construction of the data packet in one embodiment of the network of FIG. 1.

The Short Training Field (STF) is used to obtain time and frequency synchronization while the Long Training Field (LTF) is used to obtain a channel estimate for every data carrier. The LTF is followed by the PHY header which conveys information about the how the data payload should be decoded.

The cyclic prefix may be chosen to be greater than or equal to the longest delay profile that could reasonably be expected so that either demodulation method can be accommodated. The number of pilots may be chosen to be less than that required by the worst case channel so that the data rate is maximized for a large portion of the channels in use. The data packet may be constructed such that the demodulation mode employed for data payload encoding is signaled in the first portion of the data packet often referred to as the PHY Header. The PHY Header is always transmitted as a coherent modulation including data and pilot tones.

The advantages of this scheme are several. Since the channel phase for every carrier is known after reception of the LTF, and since there is little chance of the channel changing during the length of the PHY Header because it is so short, it is possible to always perform this demodulation coherently. Thus it is possible to read the Modulation Mode bit to determine the modulation mode of the data payload.

Inclusion of pilot tones within the PHY header allows channel tracking during the length of the header so that, if the modulation mode bit indicates coherent modulation for the payload, the channel estimate is accurate and demodulation can continue without further channel training.

If the mode bit indicates the use of differential encoding it is not necessary to keep the channel estimate updated during the payload and so it is not necessary to transmit pilot tones during the payload section. However, for reasons of implementation simplicity it may be convenient to leave the payload pilots in place.

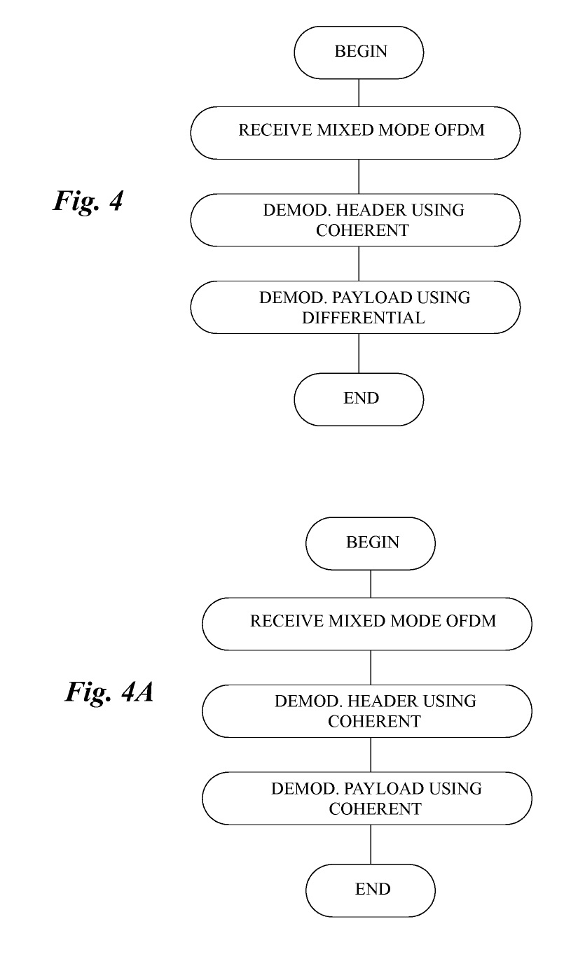

Referring to FIG. 4, in one embodiment, a receiver receives a mixed mode OFDM transmission. It demodulates a header portion using coherent demodulation. As signaled in the header portion, it then demodulates the payload using differential modulation.

Referring to FIG. 4A, in another embodiment, a receiver receives a mixed mode OFDM transmission. It demodulates a header portion using coherent demodulation. As signaled in the header portion, it then demodulates the payload using coherent modulation.

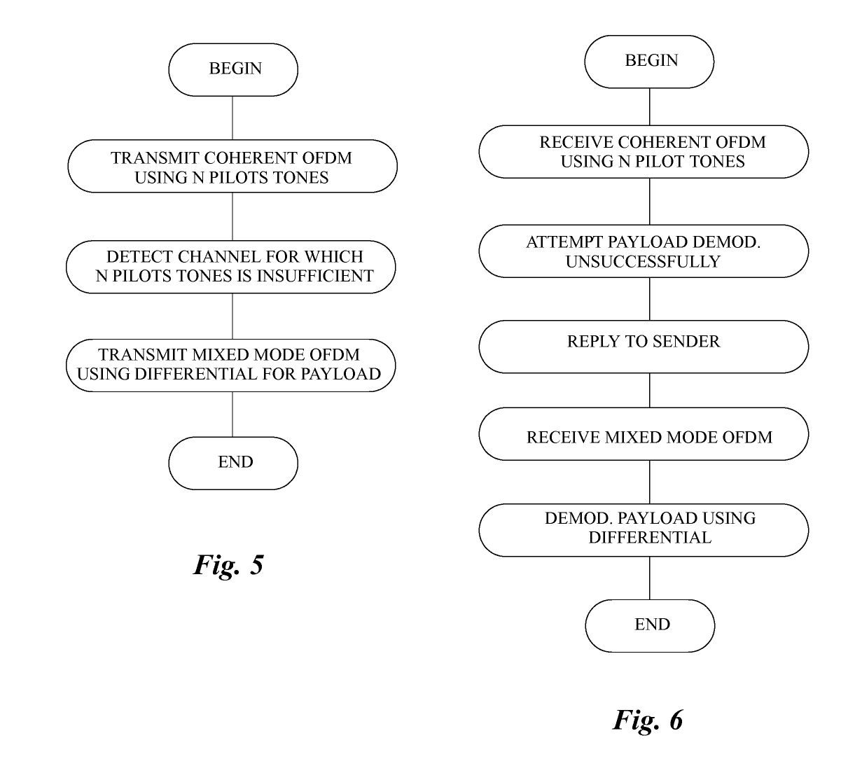

Referring to FIG. 5, in another embodiment, a transmitter transmits coherent OFDM using N pilot tones. Subsequently, it detects a channel for which N pilots tones is insufficient for demodulation of the payload. As a result, it transmits mixed mode OFDM, using differential modulation for the payload.

Referring to FIG. 6, in another embodiment, a receiver receives coherent OFDM using N pilot tones. It attempts coherent payload demodulation but is unsuccessful. It then replies to the sender, informing the sender of the failure to coherently demodulate the payload. It then receives mixed mode OFDM and demodulates the payload using differential demodulation.

### CONCLUSION

This invention optimizes the data throughput of an OFDM radio in a multipath environment by reducing the number of pilot tones to accommodate the moderate delay profile of the majority of channels.

When a radio channel with a severe delay profile renders the channel tracking inadequate a bit in the PHY Header is used to invoke differential modulation which is able to deal with the more stringent channel because it does not require pilot tones.

Normally the two modulation methods are incompatible if the receiver does not have apriori knowledge of which method will be used. This invention solves that problem.

### Further Aspects

Further aspects of the invention may include the following:
1. A neighborhood area network comprising a plurality of wireless nodes, each comprising:
   an OFDM transmitter; and
   an OFDM receiver comprising:
      a coherent demodulator;
      a differential demodulator; and
      circuitry for switching from use of the coherent demodulator to use of the differential demodulator in response to control information demodulated by the coherent demodulator.
2. A wireless network node comprising:
   an OFDM transmitter; and
   an OFDM receiver comprising:
      a coherent demodulator;
      a differential demodulator; and
      circuitry for switching from use of the coherent demodulator to use of the differential demodulator in response to control information demodulated by the coherent demodulator.
3. A method of receiving information in a wireless network, comprising:
   receiving an OFDM transmission;
   demodulating a header portion of the OFDM transmission using coherent OFDM demodulation;
   detecting control information received in the header portion of the OFDM transmission; and
   in response to the control information, demodulating a payload portion of the OFDM transmission using differential OFDM demodulation.

The invention may also be embodied in the form of executable instructions stored on a tangible, computer-readable medium.

It will be apparent to the those skilled in the art that the present invention can be embodied in other specific forms without departing from the spirit or essential character thereof. The foregoing description is therefore intended in all respects to be illustrative and not restrictive. The scope of the invention is indicated by the appended claims, not by the foregoing description, and all changes which come within the spirit and range of equivalents thereof are intended to be embraced therein.

What is claimed is:

1. A method of transmitting information in a wireless network, comprising:
transmitting information using coherent OFDM modulation and using a number of pilot tones less than an expected number of pilot tones required under expected worst-case channel conditions;
detecting a channel having channel conditions for which the number of pilots tones is insufficient; and
transmitting information on said channel using coherent OFDM modulation for a header portion of a transmission and using differential OFDM modulation for a payload portion of the transmission, wherein the header portion comprising control information signaling use of differential modulation OFDM modulation for the payload portion.

2. A method of receiving information in a wireless network, comprising:
receiving an OFDM transmission that uses coherent OFDM modulation;
attempting unsuccessfully to demodulate a payload portion of the OFDM transmission;
replying to the OFDM transmission; and
receiving a further OFDM transmission using mixed mode OFDM modulation wherein a header portion of the further OFDM transmission is modulated using coherent OFDM modulation and a payload portion of the further OFDM transmission is modulated using differential OFDM modulation.

3. A method of receiving information in a wireless network, comprising:
receiving a mixed mode OFDM transmission;
demodulating a header portion of the OFDM transmission using coherent OFDM demodulation; and
demodulating a payload portion of the OFDM transmission using differential OFDM demodulation.
